(19) United States
(12) Patent Application Publication
(10) Pub. No.: US 2016/0345612 A1
(43) Pub. Date: Dec. 1, 2016

(54) METHOD AND SYSTEM FOR MONITORING STATE OF FOOD

(71) Applicant: Wipro Limited, Bangalore (IN)

(72) Inventors: Joy Banerjee, Durgapur (IN); Baburaj Kaimalilputhenpura Prabha, Calicut (IN)

(21) Appl. No.: 14/813,335

(22) Filed: Jul. 30, 2015

(30) Foreign Application Priority Data
May 30, 2015 (IN) 2730/CHE/2015

(51) Int. Cl. A23L 3/00; A23L 3/36

(52) U.S. Cl. CPC A23L 3/003; A23L 3/36; A23V 2002/00

(57) ABSTRACT

The present disclosure relates to a method and a system for monitoring state of food. In one embodiment, the method received data related to parameters associated with food storage conditions including temperature, humidity, defrost duration and defrost stop temperature and determines deviation of the food storage conditions based on the received data. Further, the method determines deviation in temperature and duration period of deviation and notifies a user if the duration period where the food is in danger zone exceeds a predetermined critical threshold duration period. Further, the deviation of defrost duration and humidity is also determined and notified to the user accordingly so that the user may reduce the duration of opening the door of cold-room, and frequency of such opening. Thus, the present disclosure periodically determines the deviation in critical conditions and enables the user to control the operations of the food storage conditions avoiding food wastage.

### PRIORITY CLAIM

This U.S. patent application claims priority under 35 U.S.C. §119 to: Indian Application No. 2730/CHE/2015, filed on May 30, 2015. The aforementioned application is incorporated herein by reference in its entirety.

### FIELD OF THE DISCLOSURE

The present subject matter is related, in general to monitoring system, and more particularly, but not exclusively to method and a system for monitoring state of food.

### BACKGROUND

Generally, in today's age of supply chain globalization, ever-increasing consumer awareness, and evolving government regulations, there is a legitimate urgency among manufacturers to take more ownership of food safety to protect consumers and their brands. Refrigerated storage is now one of the most widely practiced methods of controlling microbial growth in perishable foods. Control of the storage temperature is vital in maintaining the quality and safety of refrigerated foods throughout the food continuum (gate to plate). As a consequence, it is important that good chill/storage procedures are in place to ensure that such foods not only achieve their required shelf lives but are safe for consumption by the end user. Conventional methods monitor the food products in a cold-room system using temperature sensors, however, such monitoring requires collection of information and detailed analysis of information which is time consuming process. Moreover, people lack the expertise to accurately analyze such information. Therefore, there is a need for method and system for monitoring state of food and overcoming the disadvantages and limitations of the existing systems.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Accordingly, the present disclosure relates to a method of monitoring state of food. The method comprising the steps of receiving data related to conditions of one or more locations where the food is stored. In one embodiment, the data is received from at least one sensor at regular time intervals, and comprises at least temperature data. The method further comprises the steps of determining deviation in temperature by comparing the received temperature data with a predetermined threshold temperature. Upon determining the deviation, the duration of the deviation between two consecutive first and second times is determined. Further, the method comprises the steps of determining whether the deviation duration exceeds predetermined critical threshold duration and generating an alarm signal indicative of state of food based on the determination.

Further, the present disclosure relates to a system for monitoring state of food. The system comprises a processor and a plurality of sensors. The system further comprises a memory communicatively coupled with the processor, wherein the memory stores processor-executable instructions, which, on execution, cause the processor to receive data related to food conditions from at least one sensor at regular time intervals, wherein the data comprises at least temperature data. The processor is further configured to determine a deviation in temperature by comparing the received temperature data with a predetermined threshold temperature. Upon determining the deviation, the processor is configured to determine duration of the deviation between two consecutive first and second times and determine whether the deviation duration exceeds predetermined critical threshold duration. The processor is furthermore configured to generate an alarm signal indicative of state of food based on the determination.

Furthermore, the present disclosure relates to a non-transitory computer readable medium including instructions stored thereon that when processed by at least one processor cause a system to perform the act of receiving data related to food conditions from at least one sensor at regular time intervals, wherein the data comprises at least temperature data. Further, the instructions cause the processor to determine a deviation in temperature by comparing the received temperature data with a predetermined threshold temperature and further determine duration of deviation between two consecutive first and second times. The processor is also configured to determine whether the deviation duration exceeds predetermined critical threshold duration and generate an alarm signal indicative of state of food based on the determination.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an architecture diagram of an exemplary system for monitoring state of food in accordance with some embodiments of the present disclosure;

FIG. 2 illustrates an exemplary block diagram of a monitoring system of FIG. 1 in accordance with some embodiments of the present disclosure;

FIG. 3 illustrates a flowchart of an exemplary method of monitoring state of food in accordance with some embodiments of the present disclosure;

FIG. 4 is a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

The present disclosure relates to a method and a system for monitoring state of food. In one embodiment, the method receive data related to parameters associated with food storage conditions including temperature, humidity, defrost duration and defrost stop temperature and determines deviation of the food storage conditions based on the received data. Further, the method determines deviation in temperature and duration period of deviation and notifies a user if the duration period where the food is in danger zone exceeds a predetermined critical threshold duration period. Further, the deviation of defrost duration and humidity is also determined and notified to the user accordingly so that the user may reduce the duration of opening the door of cold-room, and frequency of such opening. Thus, the present disclosure periodically determines the deviation in critical conditions and enables the user to control the operations of the food storage conditions avoiding food wastage.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

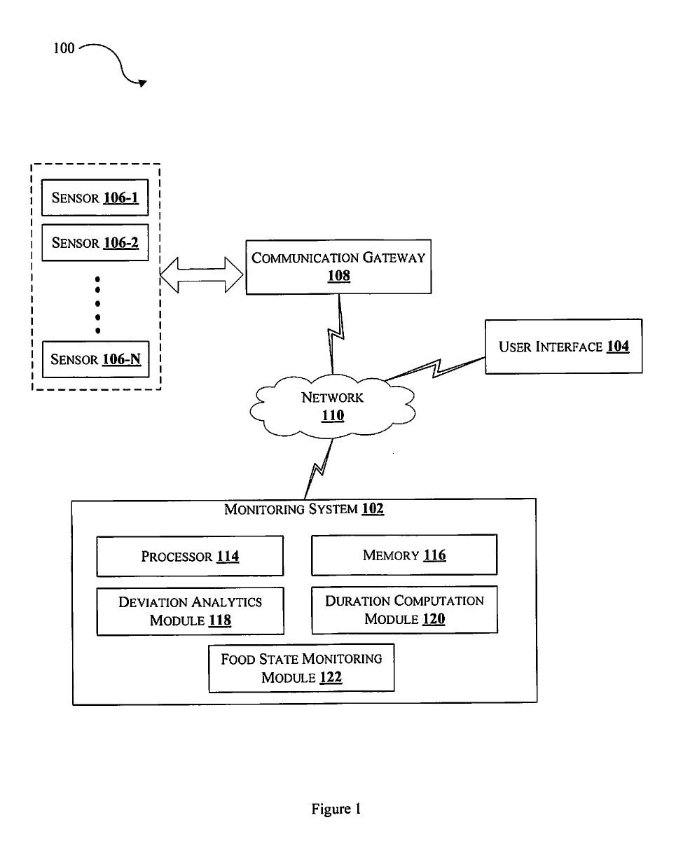

FIG. 1 illustrates an architecture diagram of an exemplary system for monitoring state of food in accordance with some embodiments of the present disclosure.

As shown in FIG. 1, the exemplary system 100 comprises one or more components configured for monitoring state of food. In one embodiment, the exemplary system 100 comprises a monitoring system 102, a user interface 104, one or more sensors 106-1, 106-2, . . . , 106-N (collectively referred to as sensors 106) and a communication gateway 108 connected via a communication network 110. The sensors 106 are configured to collect data related to environmental parameters or conditions of one or more locations where the food is stored at regular time intervals, for example 2 minutes. The sensors 106 may be for example a temperature sensor to monitor temperature, a humidity sensor to monitor the humidity, a defrost sensor to determine the defrost duration and stop temperature, a gas or a chemical sensor to monitor food toxins, and a biological sensor to detect foot microbes and so on. The sensors 106 are deployed in a food service establishment to measure internal conditions of cold-room. In one embodiment, the sensors 106 collect data relevant to internal conditions like temperature data, humidity data, defrost duration and defrost stop temperature data, etc. along with the present timestamping information of the collected measurement data. The collected data are then consolidated by a combi-sensor for example, encrypted and transmitted along with the relevant timestamping information to the monitoring system 102 via the communication gateway 108.

In one embodiment, the communication gateway 108 may include one or more interfaces for example, a first interface configured to collect data from the sensors 106 and a second interface coupled with the first interface to transmit the collected data to the monitoring system 102 via the network 110. The network 110 may be for example, the Internet, intranets, extranets, wide area networks (WANs), local area networks (LANs), wired networks, wireless networks, cellular networks, or other suitable networks, etc., or any combination of two or more such networks. The data collected by the sensors 106 are encrypted and transmitted to the monitoring system 102 via the communication network 110. The monitoring system 102 receives the data from the sensors 102, decrypts the received data into a user readable format and stores the decrypted data in the memory. In one embodiment, the monitoring system 102 may include a data receiver to receive data from the sensors 106 and a depacketizer to decrypt the received data into the user readable format. The monitoring system 102 processes the decrypted data to analyze the storage conditions of food based on the data thus received.

In one embodiment, the monitoring system 102 comprises a central processing unit (“CPU” or “processor”) 114, and a memory 116 coupled with the processor 114. The processor 114 receives the data from the sensors 106, determines deviation in the storage conditions as compared to one or more acceptable limits and alerts a system manager or a system administrator based on the deviation determination via the user interface 104. The monitoring system 102 comprises a deviation analytics module 118 configured to determine the deviation in storage conditions where the food is stored and further comprises a duration computation module 120 configured to determine the duration of such deviation. The monitoring system 102 further comprises a food state monitoring module (FSMM) 122 configured to determine whether the deviation exceeds the acceptable limit or not and notifies the system manager or the system administrator accordingly via the user interface 104. The interface 104 may be for example, an application portal configured to enable the interaction between the system manager or the system administrator and the monitoring system 102.

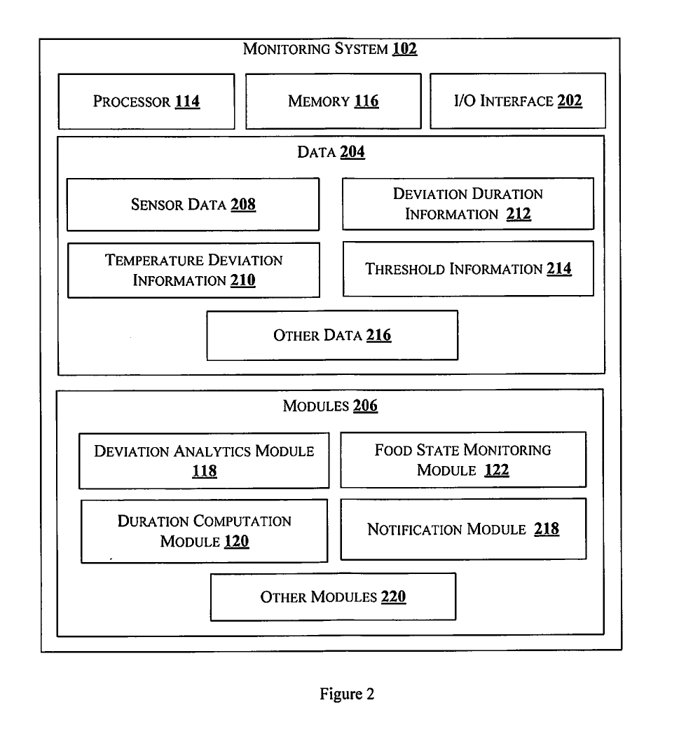

The monitoring system 102 may be a typical monitoring system as illustrated in FIG. 2. The monitoring system 102 comprises the processor 114, the memory 116 and an I/O interface 202. The I/O interface 202 is coupled with the processor 114 and an I/O device. The I/O device is configured to receive inputs via the I/O interface 202 and transmit outputs for displaying in the I/O device via the I/O interface 202. The monitoring system 102 further comprises data 204 and modules 206. In one implementation, the data 204 and the modules 206 may be stored within the memory 116. In one example, the data 204 may include sensor data 208, temperature deviation information 210, deviation duration information 212, threshold information 214 and other data 216. In one embodiment, the data 204 may be stored in the memory 116 in the form of various data structures. Additionally, the aforementioned data can be organized using data models, such as relational or hierarchical data models. The other data 216 may be also referred to as reference repository for storing recommended implementation approaches as reference data. The other data 216 may also store data, including temporary data and temporary files, generated by the modules 206 for performing the various functions of the monitoring system 102.

The modules 206 may include, for example, the deviation analytics module 118, the duration computation module 120, the FSMM 122, and a notification module 218. The modules 206 may also comprise other modules 220 to perform various miscellaneous functionalities of the monitoring system 102. It will be appreciated that such aforementioned modules may be represented as a single module or a combination of different modules. The modules 206 may be implemented in the form of software, hardware and/or firmware.

In operation, the monitoring system 102 receives the sensor data 208 from the sensors 106 and determines the deviation in food storage conditions. In one embodiment, the deviation analytics module 118 receives the sensor data 208 including at least temperature data, humidity data and a defrost duration data, and so on. The deviation analytics module 118 then determines the deviation in temperature by comparing the received temperature data with a predetermined threshold temperature. If the received temperature data is determined to exceed the predetermined threshold temperature, the deviation analytics module 118 determines that there is a deviation in temperature and further determines that the food is in the danger zone and set a deviation flag accordingly, for example as ‘1’. The deviation analytics module 118 also increments a first register whenever the deviation analytics module 118 determines that the food is in the danger zone and stores the timestamping information of the temperature data in a first temporary register of memory 116. On the other hand, if the temperature data is determined to fall below the predefined threshold temperature, then the deviation analytics module 118 determines that the food is in the safe zone and set the deviation flag accordingly, for example as ‘0’. The deviation analytics module 118 also increments a second register whenever the deviation analytics module 118 determines that the food is in the safe zone and stores the timestamping information of the temperature data in a second temporary register of memory 116. Upon determining the deviation in temperature, the duration computation module 120 determines the duration of such deviation.

In one embodiment, the duration computation module 120 determines the duration by calculating the difference between two consecutive times for example, a first time and a second time. In one example, the first time indicates a first timestamping when the deviation in temperature is determined i.e., when the received temperature data exceeds the predetermined threshold temperature, and the second time indicates a second timestamping when the deviation in temperature is not determined i.e., when the received temperature data is below the predetermined threshold temperature. In one example, the duration computation module 120 determines the difference between the first register data and the second register data to determine the duration of the danger zone and notify the user or the system manager accordingly. Upon determining the duration of deviation, the FSMM 122 determines the duration when the food has been in danger zone and how frequently the food has been exposed in such danger situation and further determines as to when the storage conditions have not met the standard requirements.

In one embodiment, the FSMM 122 determines as to whether the duration period of deviation exceeds a predetermined threshold limit associated with food safety and sets a critical flag as high or low based on the determination. In one example, if the duration period is determined to fall below the predetermined threshold limit, then the FSMM 122 sets the critical flag as ‘Low’ indicating that the food may not be in danger zone and monitor continuously. In another example, if the duration period is determined to exceed the predetermined threshold limit, then the FSMM 122 sets the critical flag as ‘High’ signaling that the food may be in danger zone. Upon determining the deviation in duration period and critical flag as ‘High’, the FSMM 122 determines deviation of other storage conditions including defrost duration and humidity.

In one embodiment, the FSMM 122 determines if the defrost duration data and humidity data thus received from the sensors 106 also deviates from the respective predetermined threshold limits. In one implementation, the FSMM 122 determines whether the defrost duration data and humidity data thus received from the sensors 106 exceeds the respective predetermined threshold limits. Based on the determination, one or more notifications are generated and transmitted to the user. In one embodiment, the notification module 218 generates an alarm signal or one or more first notifications to the system manager or the system administrator via the user interface 104 upon determining the deviation in duration data and humidity data. In addition to the alarm signal, the notification module 218 determines a count of deviations during defrost duration, maximum defrost duration and the count of times when the defrost stop temperature exceeded and generates one or more second notifications based on the determination. The second notifications enable the system manager to control the operations of the food storage conditions for example, recommending reducing the duration when the door of cold-room is opened, and frequency of such opening of doors. The second notifications thus enable the user to determine when the critical danger zone is under control and how to control if the danger zone still exists.

Thus, the system 100 periodically determines the deviation in critical conditions or limits to avoid the degradation of food and reactions of potentially hazard food. Further, the system 100 enables the user to control the operations of the food storage conditions so as to reduce the food wastage and the operational cost and enable the user to understand the danger food storage situations.

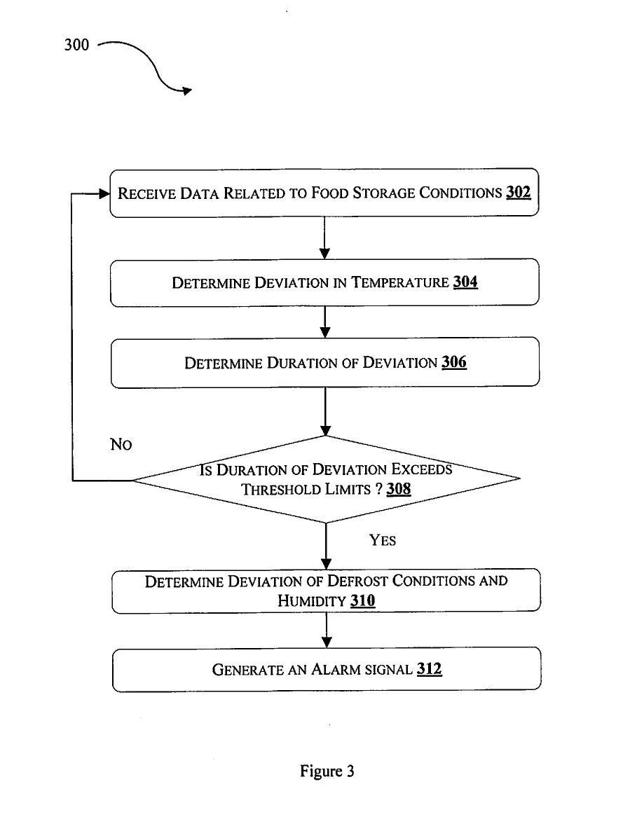

FIG. 3 illustrates a flowchart of a method of monitoring state of food in accordance with some embodiments of the present disclosure.

As illustrated in FIG. 3, the method 300 comprises one or more blocks implemented by the processor 114 for monitoring state of food. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method 300. Additionally, individual blocks may be deleted from the method 300 without departing from the spirit and scope of the subject matter described herein. Furthermore, the method 300 can be implemented in any suitable hardware, software, firmware, or combination thereof.

At block 302, receive data related to food storage conditions. In one embodiment, the monitoring system 102 receives the sensor data 208 from the sensors 106 and determines the deviation in food storage conditions. In one embodiment, the sensors 106 collect and encrypt sensor data 208 relevant to ambient conditions like temperature data, humidity data, defrost duration and stop temperature data, etc. along with the present timestamping information of the collected data and transmit to the monitoring system 102. The monitoring system 102 may include a data receiver to receive sensor data 208 from the sensors 106 and a depacketizer to decrypt the received encrypted sensor data 208 into the user readable format.

At block 304, determine deviation in temperature. In one embodiment, the deviation analytics module 118 receives the sensor data 208 including at least the temperature data and determines the deviation in temperature by comparing the received temperature data with a predetermined threshold temperature. If the received temperature data is determined to exceed the predetermined threshold temperature, the deviation analytics module 118 determines that there is a deviation in temperature and further determines that the food is in the danger zone and set a deviation flag accordingly, for example as ‘1’. The deviation analytics module 118 also increments a first register whenever the deviation analytics module 118 determines that the food is in the danger zone and stores the timestamping information of the temperature data in a first temporary register of memory 116. On the other hand, if the temperature data is determined to fall below the predefined threshold temperature, then the deviation analytics module 118 determines that the food is in the safe zone and set the deviation flag accordingly, for example as ‘0’. The deviation analytics module 118 also increments a second register whenever the deviation analytics module 118 determines that the food is in the safe zone and stores the timestamping information of the temperature data in a second temporary register of memory 116. Upon determining the deviation in temperature, the duration computation module 120 determines the duration of such deviation.

At block 306, determine duration of deviation. In one embodiment, the duration computation module 120 determines the duration by calculating the difference between two consecutive times for example, a first time and a second time. In one example, the first time indicates a first timestamping when the deviation in temperature is determined i.e., when the received temperature data exceeds the predetermined threshold temperature, and the second time indicates a second timestamping when the deviation in temperature is not determined i.e., when the received temperature data is below the predetermined threshold temperature. In one embodiment, the duration computation module 120 determines the difference between the first register data and the second register data to determine the duration of the danger zone and notify the user or the system manager accordingly. Upon determining the duration of deviation, the FSMM 122 determines the duration when the food has been in danger zone and how frequently the food has been exposed in such danger situation and further determines as to when the storage conditions have not met the standard requirements.

At block 308, determine if the duration of deviation exceed threshold limits. In one embodiment, the FSMM 122 determines as to whether the duration period of deviation exceeds a predetermined threshold limit associated with food safety and sets the critical flag as high or low based on the determination. In one example, if the duration period is determined to exceed the predetermined threshold limit, then the FSMM 122 sets the critical flag as ‘High’ signaling that the food may be in danger zone and the method flows to block 310 along the ‘YES’ path. In another example, if the duration period is determined to fall below the predetermined threshold limit, then the FSMM 122 sets the critical flag as ‘Low’ indicating that the food may not be in danger zone and the method flows to block 302 along the ‘NO’ path to monitor continuously.

At block 310, determine deviation of defrost conditions and humidity. In one embodiment, if the deviation in duration is determined at block 308, the monitoring system 102 determines deviation of other storage conditions including defrost duration and humidity. In one implementation, the FSMM 122 determines whether the defrost duration data and humidity data thus received from the sensors 106 exceeds the respective predetermined threshold limits. Based on the determination, one or more notifications are generated and transmitted to the user.

At block 312, generate an alarm signal. In one embodiment, the notification module 218 generates an alarm signal or one or more first notifications to the system manager or the system administrator via the user interface 104 indicating the deviation in critical storage conditions to avoid the degradation of food and reactions of potentially hazard food. In addition to the alarm signal, the notification module 218 determines a count of deviations during defrost duration, maximum defrost duration and the count of times when the defrost stop temperature exceeded and generates one or more second notifications based on the determination. The second notifications enable the system manager to control the operations of the food storage conditions for example, recommending reducing the duration when the door of cold-room is opened, and frequency of such opening of doors. The second notifications thus enable the user to determine when the critical danger zone is under control and how to control if the danger zone still exists.

Thus, the system 100 periodically determines the deviation in critical conditions or limits to avoid the degradation of food and reactions of potentially hazard food. Further, the system 100 enables the user to control the operations of the food storage conditions so as to reduce the food wastage and the operational cost and enable the user to understand the danger food storage situations.

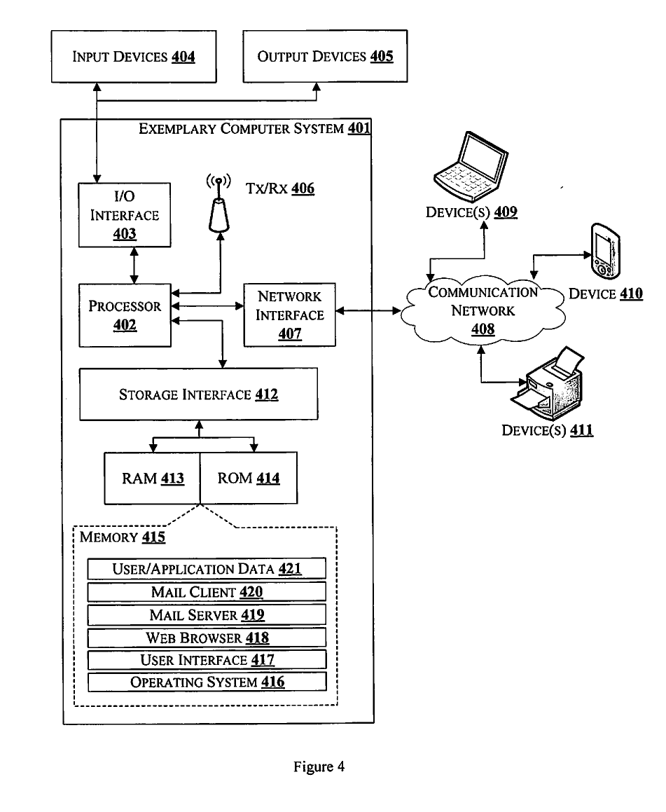

FIG. 4 is a block diagram of an exemplary computer system for implementing embodiments consistent with the present disclosure.

Variations of computer system 401 may be used for implementing all the computing systems that may be utilized to implement the features of the present disclosure. Computer system 401 may comprise a central processing unit (“CPU” or “processor”) 402. Processor 402 may comprise at least one data processor for executing program components for executing user- or system-generated requests. The processor may include specialized processing units such as integrated system (bus) controllers, memory management control units, floating point units, graphics processing units, digital signal processing units, etc. The processor 402 may include a microprocessor, such as AMD Athlon, Duron or Opteron, ARM's application, embedded or secure processors, IBM PowerPC, Intel's Core, Itanium, Xeon, Celeron or other line of processors, etc. The processor 402 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 402 may be disposed in communication with one or more input/output (I/O) devices via I/O interface 403. The I/O interface 403 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 403, the computer system 401 may communicate with one or more I/O devices. For example, the input device 404 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 405 may be a printer, fax machine, video display (e.g., cathode ray tube (CRT), liquid crystal display (LCD), light-emitting diode (LED), plasma, or the like), audio speaker, etc. In some embodiments, a transceiver 406 may be disposed in connection with the processor 402. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 402 may be disposed in communication with a communication network 408 via a network interface 407. The network interface 407 may communicate with the communication network 408. The network interface 407 may employ connection protocols including, without limitation, direct connect, Ethernet (e.g., twisted pair 10/40/400 Base T), transmission control protocol/internet protocol (TCP/IP), token ring, IEEE 802.11a/b/g/n/x, etc. The communication network 408 may include, without limitation, a direct interconnection, local area network (LAN), wide area network (WAN), wireless network (e.g., using Wireless Application Protocol), the Internet, etc. Using the network interface 407 and the communication network 408, the computer system 401 may communicate with devices 409, 410, and 411. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 401 may itself embody one or more of these devices.

In some embodiments, the processor 402 may be disposed in communication with one or more memory devices (e.g., RAM 413, ROM 4Error! Reference source not found.14, etc.) via a storage interface 412. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 415 may store a collection of program or database components, including, without limitation, an operating system 4Error! Reference source not found.16, user interface application 5Error! Reference source not found.17, web browser 418, mail server 419, mail client 420, user/application data 421 (e.g., any data variables or data records discussed in this disclosure), etc. The operating system 416 may facilitate resource management and operation of the computer system 401. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 417 may facilitate display, execution, interaction, manipulation, or operation of program components through textual or graphical facilities. For example, user interfaces may provide computer interaction interface elements on a display system operatively connected to the computer system 401, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 401 may implement a web browser 418 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 401 may implement a mail server 419 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 420 stored program component. The mail client may be a mail viewing application, such as Apple Mail, Microsoft Entourage, Microsoft Outlook, Mozilla Thunderbird, etc.

In some embodiments, computer system 401 may store user/application data 421, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

As described above, the modules 206, amongst other things, include routines, programs, objects, components, and data structures, which perform particular tasks or implement particular abstract data types. The modules 206 may also be implemented as, signal processor(s), state machine(s), logic circuitries, and/or any other device or component that manipulate signals based on operational instructions. Further, the modules 206 can be implemented by one or more hardware components, by computer-readable instructions executed by a processing unit, or by a combination thereof.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

We claim:

1. A method of monitoring state of food, said method comprising:
receiving, by a processor of a food state monitoring system, from at least one sensor at regular time intervals, data related to conditions of one or more locations where the food is stored wherein the data comprises at least temperature data;
determining, by the processor, a deviation in temperature by comparing the received temperature data with a predetermined threshold temperature;
deriving, by the processor, duration of the deviation between two consecutive first and second times;
determining, by the processor, whether the deviation duration exceeds a predetermined critical threshold duration; and
generating, by the processor, an alarm signal indicative of state of food based on the determination.

2. The method as claimed in claim 1, wherein the first time indicates a first timestamping when the deviation in temperature is determined and the second time indicates a second timestamping when no deviation in temperature is determined.

3. The method as claimed in claim 1, further comprising receiving data including at least a humidity data, and a defrost duration data.

4. The method as claimed in claim 3, further comprising:
setting a deviation flag if the duration of deviation is determined to exceed the predetermined critical threshold;
upon setting the deviation flag, determining if the defrost duration data and humidity data deviates from the respective predetermined threshold limits; and
generating the alarm signal indicative of deviation upon determination.

5. The method as claimed in claim 1, further comprising:
determining a count of deviations during defrost duration and maximum of one or more defrost deviation durations recorded for a predetermined time period; and
transmitting one or more notifications to a user to control the operations of handling the food based on the count of deviations and maximum defrost deviation duration thus determined.

6. A system for monitoring state of food, said system comprising:
a processor;
a plurality of sensors communicatively coupled with the processor; and
a memory disposed in communication with the processor and storing processor-executable instructions, the instructions comprising instructions to:
receive data related to food conditions from at least one sensor at regular time intervals, wherein the data comprises at least temperature data;
determine a deviation in temperature by comparing the received temperature data with a predetermined threshold temperature;
derive duration of deviation between two consecutive first and second times;
determine whether the deviation duration exceeds a predetermined critical threshold duration; and
generate an alarm signal indicative of state of food based on the determination.

7. The system as claimed in claim 6, wherein the processor is configured to determine the first time indicative of a first timestamping when the deviation in temperature is determined and the second time indicative of a second timestamping when no deviation in temperature is determined.

8. The system as claimed in claim 6, wherein the processor is further configured to receive data including at least a humidity data, and a defrost duration data from the plurality of sensors.

9. The system as claimed in claim 8, wherein the processor is further configured to:
set a deviation flag if the duration of deviation is determined to exceed the predetermined critical threshold;
upon setting the deviation flag, determine if the defrost duration data and humidity data deviates from the respective predetermined threshold limits; and
generate the alarm signal indicative of deviation upon determination.

10. The system as claimed in claim 6, wherein the processor is further configured to:
determine a count of deviations during the defrost duration and maximum of one or more defrost deviation durations recorded for a predetermined time period; and
generate one or more notifications to a user to control the operations of handling the food based on the count of deviations and maximum defrost deviation duration thus determined.

11. A non-transitory computer readable medium including instructions stored thereon that when processed by at least one processor cause a system to perform acts of:
receiving data related to food conditions from at least one sensor at regular time intervals, wherein the data comprises at least temperature data;
determining a deviation in temperature by comparing the received temperature data with a predetermined threshold temperature;
deriving duration of deviation between two consecutive first and second times;
determining whether the deviation duration exceeds a predetermined critical threshold duration; and
generating an alarm signal indicative of state of food based on the determination.
